(19) United States
(12) Patent Application Publication
(10) Pub. No.: US 2014/0244348 A1
(43) Pub. Date: Aug. 28, 2014

(54) MERCHANT-DIRECTED COMPUTER-BASED COMMERCIAL PLATFORM USABLE WITH A MARKETPLACE

(71) Applicants: Payam Zamani, Danville, CA (US); Paul Charles O'leary, San Francisco, CA (US)

(72) Inventors: Payam Zamani, Danville, CA (US); Paul Charles O'leary, San Francisco, CA (US)

(21) Appl. No.: 13/781,645

(22) Filed: Feb. 28, 2013

(51) Int. Cl. G06Q 30/02

(52) U.S. Cl. CPC G06Q 30/0201
USPC 705/7.29

(57) ABSTRACT

A system and a method are disclosed a self-service computing platform having a software interface, such as a webpage, which allows a merchant or advertiser to create a customized merchant platform and use it to enroll or register itself in a marketplace. In various embodiments, a webpage is provided pre-filled merchant-specific information including offers and incentives related to customer leads. A Customer Relationship Management (CRM) service is provided to assist the merchant in contacting and managing the given customer leads. Dynamic CRM (DCRM) and Advertiser CRM (ACRM) services may further assist the merchant in managing the sales and marketing activities relating to the given customers. Such activities may include contacting, engaging, status inquiry, and sales with respect to customers whose lead information were provided to the merchant. In various embodiments, incentives given to the merchant may include new customer leads, credits, discounts, services, and the like.

### CROSS-REFERENCE(S) TO RELATED APPLICATION(S)

This application is related to U.S. application Ser. No. 13/652,246, filed on 2 Jan. 2013, the disclosure of which is hereby expressly incorporated by reference in its entirety.

### TECHNICAL FIELD

This patent application relates generally to merchants and commercial platforms. More specifically, this application relates to a self-service computer-based commercial platform used as a marketing and customer relationship management tool.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example marketplace for trading commercial leads;

FIG. 4 shows an example self-service marketplace platform environment configured to be used with the marketplace of FIG. 3;

FIGS. 5 shows an example computer user interface of the self-service marketplace platform of FIG. 4, configured to be used by a merchant for self-enrolling in the commercial leads marketplace;

FIGS. 6-10 show the example user interface of FIG. 5 at various stages of merchant self-enrolment and corresponding data entries, as further detailed in the Detailed Description section below;

FIG. 11 shows an example computer user interface of the self-service marketplace platform of FIG. 4, configured to show a merchant's activity status and actions in the marketplace; and

FIG. 12 shows an example flow diagram showing a process of taking actions on a lead opportunity obtained from the lead marketplace.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references a web-based user interface, it will be appreciated that the disclosure may be used with other types of user interface, such as application dialog boxes, server side windows, client side windows, and the like.

Briefly described, a system and a method are disclosed including a self-service computing platform having a software interface, such as a webpage, which allows a merchant or advertiser to create a customized merchant platform and use it to enroll or register itself in a marketplace. In various embodiments, a webpage is provided to the merchant with pre-filled merchant-specific information including offers and incentives related to customer leads. A Customer Relationship Management (CRM) service is provided to assist the merchant in contacting and managing the given customer leads. Dynamic CRM (DCRM) and Advertiser CRM (ACRM) services may also be made available to further assist the merchant in managing the sales and marketing activities relating to the given customers. Such activities may include contacting, engaging, status inquiry, and sales with respect to customers whose lead information were provided to the merchant. In various embodiments, incentives given to the merchant may include new customer leads, credits, discounts, services, and the like.

The commercial success of a business depends on customers that may be first identified and approached through customer leads, which include customer identifying and/or contact information. Lead information may take any form, including online information, lists, referrals, and the like. As such, leads are valuable commodities and assets usable for sales and marketing activities, which leads themselves may be bought and sold in a lead marketplace. The internet is a particularly suitable medium for exchanging leads, for example, in an online lead marketplace, because real-time updates and quick actions can take place more easily than in other environments. However, obtaining leads in only the first step in making a successful sale to a customer. Easy and coordinated access to a lead marketplace, CRM tools, follow-up, status updates, and feedback are all important steps in the sales process.

### Illustrative Operating Environment

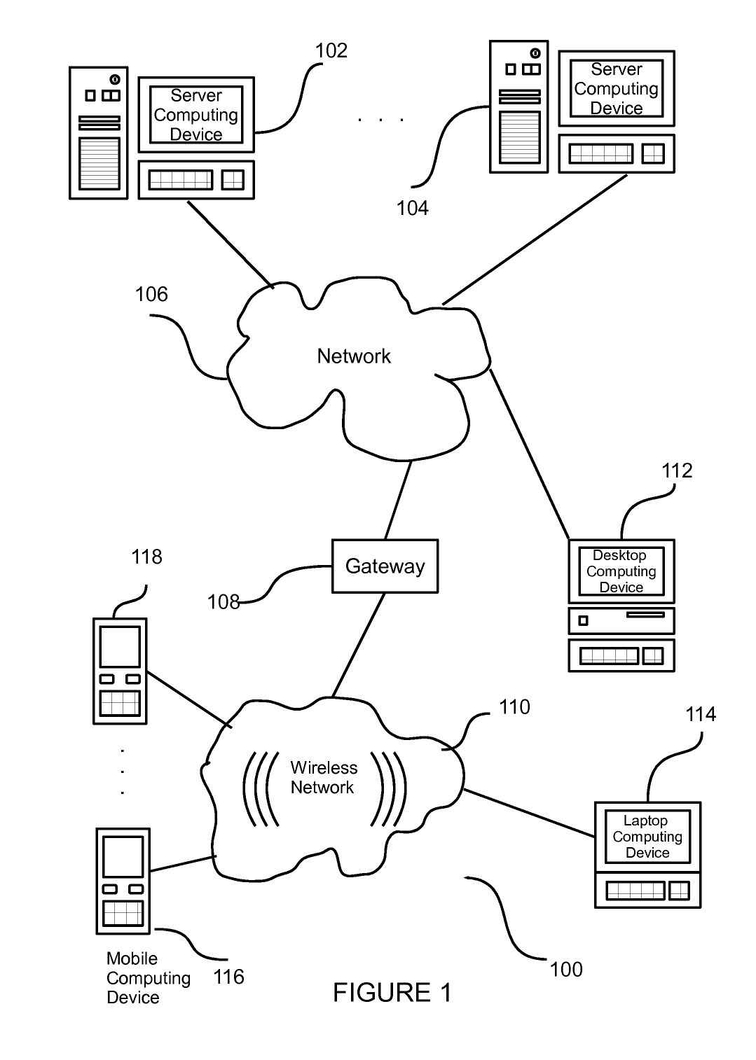

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

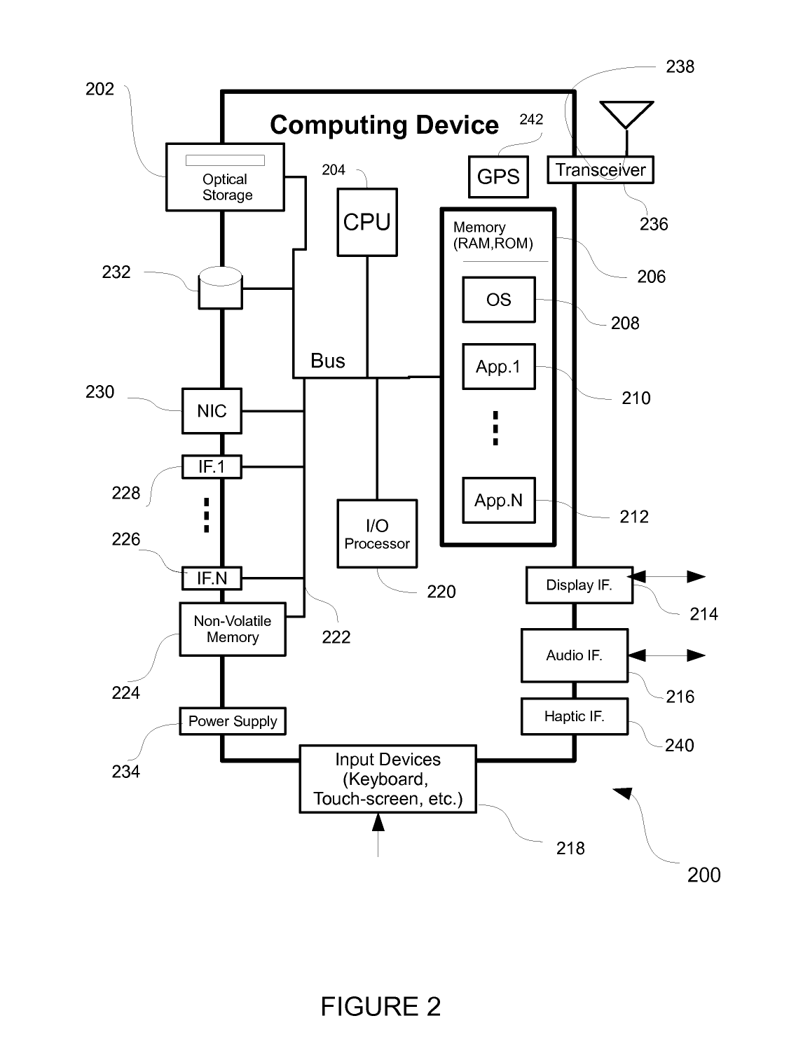

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

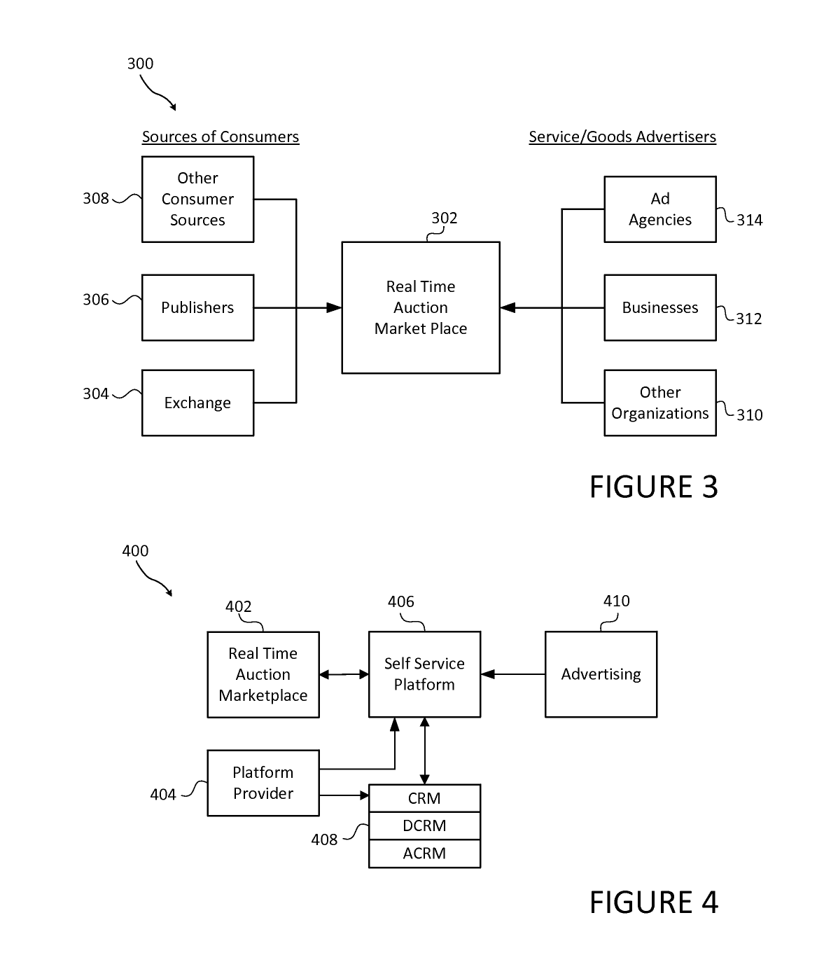

FIG. 3 shows an example marketplace for trading commercial leads. Marketplace 300 may include real time auction facility 302, sources of consumers including exchange boards 304, publishers 306, and other consumer sources 308; and service or product advertisers including advertising agencies 314, businesses 312, and other organizations 310.

In various embodiments, auction facility 302 may be an online interface, such as a webpage, to which multiple users may log on to exchange sales leads. Generally, sales leads are potential customers for goods or services. Merchants are interested in obtaining a list of such potential customers to follow up and increase their sales volume. Auction facility 302 may thus be an electronic sales marketplace used to sell or buy sales leads for different industries, goods, or services. Service and/or good providers or advertisers are generally buyers of leads and sources of consumers are generally providers or sellers of consumer leads. For example, industry-specific exchanges such as contractor finding sites or other professional or commercial exchange sites may compile lists of highly relevant leads seriously looking for a specific types of goods or services, which may then be sold to other merchants in the same industry for follow-up. Similarly, publishers who publish and/or distribute advertisements may have access to highly relevant leads.

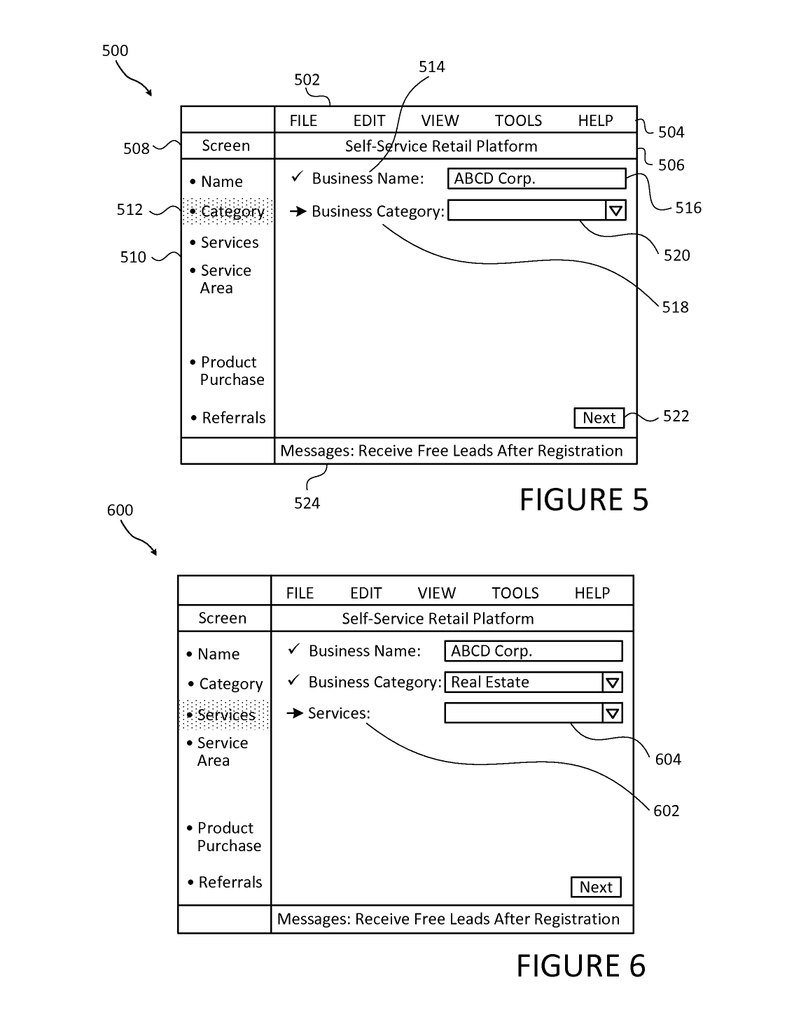

In various embodiments, a platform provider may provide a user interface for accessing an electronic sales marketplace, obtaining sales leads, and going through the sales process in an orderly and timely manner to increase the utilization of the obtained leads. In some embodiments, the platform is computer based and allows multiple merchants, advertisers, and generally lead buyers to log in and access the market. In other embodiments, the platform provider may provide access to a private interface customized for a particular merchant by the platform provider or a third party. In this embodiment, the merchant may be given the opportunity and computing facilities tailored to the merchant's business and practices and provide real time and/or aggregate data and statistics for its sales activities, as further described below with respect to FIGS. 4-10.

FIG. 4 shows an example self-service marketplace platform environment configured to be used with the marketplace of FIG. 3. In various embodiments, marketplace platform environment 400 includes one or more of real-time marketplace 402, platform provider 404, self-service platform 406, CRM services 408, and merchants or advertisers 410.

In various embodiments, real-time marketplace 402 is similar to real-time auction facility 302 of FIG. 3, and is configured to provide lead information for sale or purchase to the users of the lead marketplace. In some embodiments, the marketplace may be an electronic exchange, implemented using computing devices as described with respect to FIGS. 1 and 2, configured to allow electronic transactions to take place for the sale or purchase of leads and related data and information.

The marketplace may include data about individual leads as well as statistical and/or aggregate data about the marketplace, or segments of the marketplace. In some embodiments, the marketplace 402 may be specialized and configured to present leads in a particular market related to only certain goods and services, while in other embodiments, the marketplace may be configured as an open exchange for leads in most markets related to most goods and services. For example, a specialized marketplace may only offer leads for the real estate industry, the automotive industry, the hospitality industry, the farm industry, and the like, while a general marketplace may offer leads for substantially all vertical, cross-vertical, and horizontal markets.

In various embodiments, the platform provider may be an organization which provides computing facilities and interface to the real-time marketplace 402. For example, the platform provider may provide a website for merchants to log in and access the marketplace for exchanging leads or monitor market conditions. In some embodiments the platform provider may also own and/or operate the real-time lead marketplace, while in other embodiments, the marketplace may be owned and/or operated by a third party, and the platform provider may only provide the marketplace interface. Those skilled in the art will appreciate that the platform provider may provide the marketplace interface using many other computing facilities and techniques without departing from the spirit of the present disclosures. For example, the platform provider may provide a client-side application, a server side application, a web service to a third party interface provider, and the like.

In various embodiments, self-service platform 406 may be a computing environment that allows advertiser 410 to connect to and interact with the real-time marketplace 402. In some embodiments, self-service platform 406 is configured to allow self-registration or enrolment of the advertiser and further allow the creation of a customized computing platform. Self-registration may result in the creation of a customer computing platform having a custom account for the merchant or advertiser, which is associated with the platform provider. The custom account and other components and services may constitute a customized marketplace computing platform from the perspective of the advertiser, which provides all the computing, data, and interface facilities the advertiser needs to interact with the marketplace. Those skilled in the art will appreciate that the self-service platform 406 and its associated services and functions may be implemented by or embodied in one or more software modules running on a computing device similar to those described with respect to FIGS. 1 and 2.

The merchant account may allow configurable and traceable transactions between the advertiser or merchant and the lead market. In some embodiments, the platform provider may provide additional services to the advertiser, such as incentives, leads, CRM services, reports, feedbacks, and the like. In some embodiments, the self-service platform is a customized web page including information about the advertiser performing self-enrolment, such as the advertiser's name, address, business category, and the like. In other embodiments, the self-service platform may be a custom software application configured to provide the interface and various services associated with the use of the marketplace.

In various embodiments, relationship and/or business management services, such as CRM, DCRM, ACRM services 408, and other similar services associated with the platform provider may be provided to the merchant or advertiser 410. Those skilled in the art will appreciate that the CRM/DCRM/ACRM services may be implemented by or embodied in one or more software modules running on a computing device similar to those described with respect to FIGS. 1 and 2. The CRM services allow the advertiser to manage its customer relationships and data including contact information, business processes, sales activities, marketing, service calls, appointments, transaction history, service requirements, special instructions, reports, trends, analytics, statistical data, social network accounts, and the like. Generally, such customer data are maintained in a database, which may be remote or local.

In various embodiments, DCRM allows the real-time, semi-real-time, or periodic update of the merchant's customer information in CRM. In various embodiments, DCRM may be built and deployed on top of an existing CRM application, while in other embodiments, the DCRM may be an independent software application. In some embodiments, DCRM may operate automatically by updating information changes in the database as the changes take place or when they are detected. In other embodiments, DCRM may be operated manually, for example, by an account manager, who may update such data periodically as needed. Still in other embodiments, DCRM may provide automatic or manual updates based on user preferences or configuration.

In various embodiments, ACRM augments CRM and/or DCRM by providing data and information about the merchant or advertiser, in contrast to the information about the customers of the merchant, its status, current and planned actions, reports, analytics, statistics, past performance, and the like. In various embodiments, ACRM may be built and deployed on top of an existing CRM and/or DCRM application, while in other embodiments, the ACRM may be an independent software application. In some embodiments, ACRM may be integrated with CRM/DCRM and provide an integrated environment for the merchant to keep track of itself and its customers via a single interface, while in other embodiments, ACRM may be presented as a separate interface, even if it is built on top of the CRM.

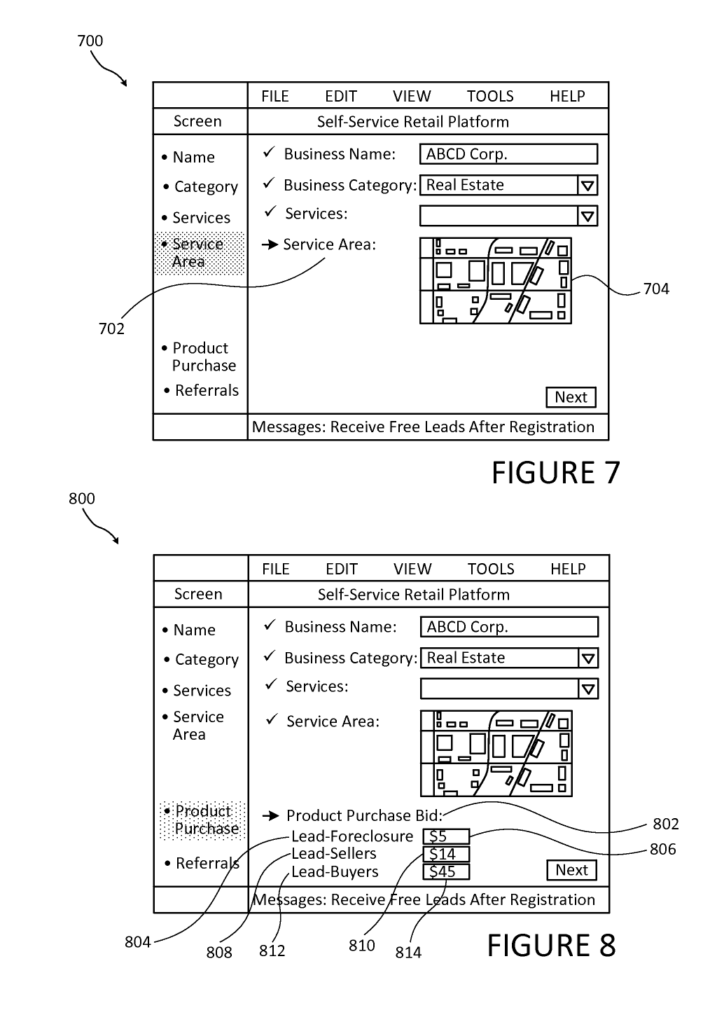

FIGS. 5 shows an example computer user interface of the self-service marketplace platform of FIG. 4, configured to be used by a merchant for self-enrolling in the commercial leads marketplace. In various embodiments, self-service platform interface screen 500 includes a graphical interface 520, such as a webpage, having menu bar 504, title bar 506, screen label 508, screen navigation pane 510, current screen 512, previous screen identifier 514, text field 516 showing previous screen information, current screen identifier 518, current screen information field 520, next screen navigation button 522, and message and/or status area 524.

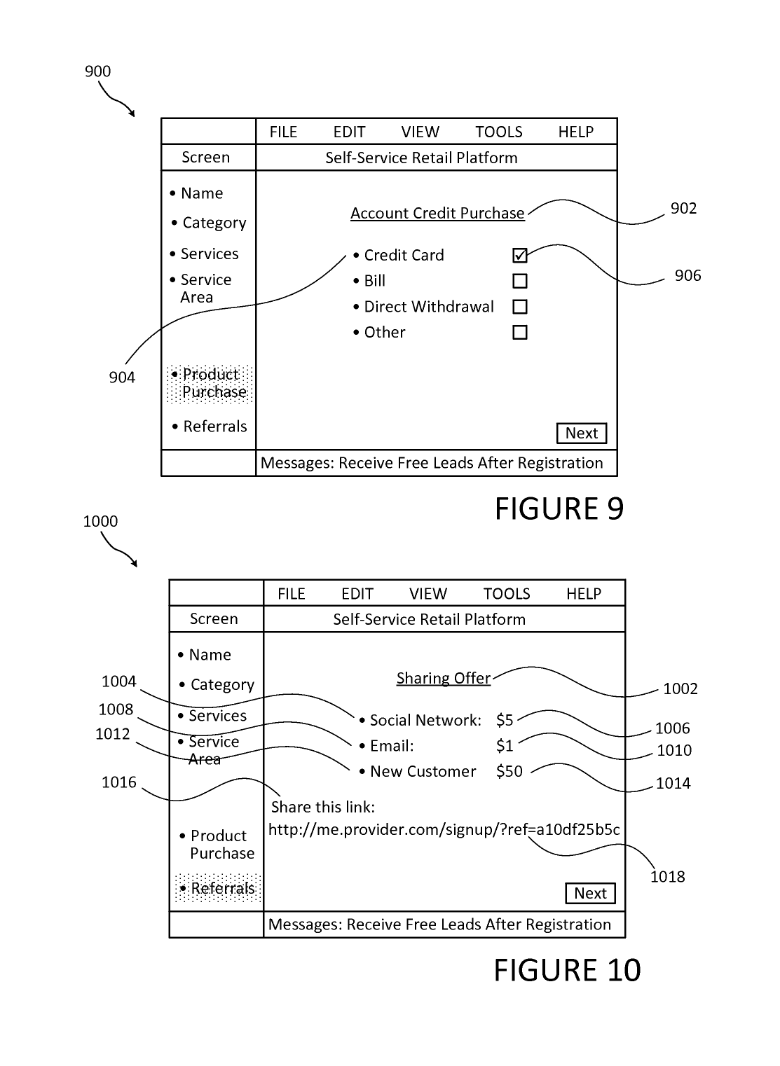

In various embodiments, a user such as a merchant or advertiser, may receive an invitation in the form of a hot link embedded in an email or other message, for example, via networks and computing devices as described with respect to FIGS. 1 and 2. By selecting that link, the advertiser is directed to the self-service graphical interface 520 to start the process of enrollment or registration. The graphical interface 520 may be customized/personalized and have been provisioned with some pre-determined data specific to the advertiser, such as the advertiser's name, address, and business category, among others. The advertiser is then directed to go through a series of screens, each requesting a particular type of information to be provided by the advertiser, before moving on to the next screen, as described below with respect to FIGS. 6-10. Those skilled in the art will appreciate that for self-registration and data collection many other user interface techniques may be used. For example, instead of the user going through multiple screens in sequence, all information requests may be presented in on screen, collected via a question and answer dialog box, entered into an editable form by the user and then uploaded, and the like.

In various embodiments, screen navigation pane 510 is used to display all or the next few screens the user needs to traverse to fill in the information requested. The navigation pane may also indicate the current screen or step in the information collection and registration process, by shading, color coding, highlighting, underlining, or otherwise emphasizing the current screen identifier. In some embodiments, the user may be allowed to access a screen out of sequence, for example, to go back a few screens to correct or change some information already entered, or to access a few screens ahead of the current position to see what data is expected to be entered later.

In various embodiments, the data already entered may be displayed to the user via a summary data list on the interface to provide an overall view of the data entered so far. As the process of self-registration or self-enrolment progresses, more data are added to the summary information list to keep the user up to date.

In various embodiments, message/status area 524 may be used to advise user of various information, provide usage tips, provide incentives, advertise other services of the platform provider, or provide any other appropriate message or information. The message area may also be used to provide online instructions to the user entering data.

In various embodiments, business category data may be entered in data field 520 by the user, or it may be pre-filled when presented to the user. In various embodiments, data field 520 may be a text field, a pick list, radio buttons, or other graphical interface for data entry. Once the user is finished with the current screen, he may be prompted to move to the next screen, for example, by selecting the “Next” button 522.

FIGS. 6-10 show the example user interface of FIG. 5 at various stages of merchant self-enrolment and corresponding data entries, as further detailed in the Detailed Description section below. In various embodiments, service screen 600 includes substantially the same elements described above with respect to FIG. 5, further including merchant service data 602 entered or selected by the user using data field 604.

In various embodiments, in each of the data entry screens, user interface options, such as an “Add” button, may be provided to the user to add more data fields for entering additional data, as appropriate. For example, in service screen 600, a merchant may provide multiple services to its customers. As such, the user may add more data entry fields. similar to data field 604, to allow the user to enter data related to additional services the merchant provides. Upon completing entering the service screen data, the user moves on to the next data entry screen.

FIG. 7 shows an example service area screen 700. In various embodiments, service area 702 may be specified by map 704, which may be appropriately highlighted or otherwise marked to show service area boundaries, while in other embodiments, textual description of the service area boundaries may be entered. The textual description may include names of boundary landmarks such as roads, streets, rivers, and the like, or be specified in terms of metes and bounds. Upon completing entering the service area screen data, the user moves on to the next data entry screen.

FIG. 8 shows an example product purchase bid screen 800. In various embodiments, product purchase bid 802 includes various products offered by the platform provider, or a third party product provider, such as sales leads for various sales and marketing activities. For example, in a real estate business, leads may be offered for bidding including foreclosure properties leads 804, property buyers leads 808, or property sellers leads 812, among others. Each such product bid may be associated with a bid price entry field, such as lead bid data fields 806, 810, and 814 for foreclosures, buyers, and sellers, respectively. Those skilled in the art will appreciate that for each business category, the product categories and their respective leads vary as appropriate for the business category. For example, for an advertiser in the construction business, the lead categories may include new construction, remodel, and repair leads; and for an advertiser in insurance business, the lead categories may include life insurance, home insurance, and auto insurance leads.

In various embodiments, the bidding process may be a real-time competitive bid against other lead buyers in the lead marketplace, while in other embodiments, the bidding process includes a static or blind bid that is later compared with other bids to determine the price and/or purchasing outcome for various bidders. Upon completing entering the bidding screen data, the user moves on to the next data entry screen.

FIG. 9 shows an example account credit purchase screen 900. In various embodiments, the advertiser may open a credit account with the platform provider and/or a third party product provider to allow the advertiser to purchase and/or bid for lead products. Account credit purchase options 902 may include payment by credit card 904, selected by checkmark or other graphical indication, direct payment, direct withdrawal from a bank account, or other methods of payment. In operation, as the user bids for or purchases various lead products, the merchant's credit account is charged and replenished as necessary by the platform provider, marketplace operator, third party product provider, and the like.

FIG. 10 shows an example client sharing screen 1000. In various embodiments, the advertiser or merchant performing self-registration may be offered incentives via the marketplace platform to share information about other potential advertisers, for example as referrals, with the platform provider or third party product provider. In various embodiments, the shared information may include the potential advertiser's social network 1004, email 1008, or other types of contact information. The sharing offer 1002 may include various financial or lead rewards, such as rewards 1006 and 1010 for social network and email information, respectively. Other extended rewards may include a new customer reward 1014 for a potential advertiser that was referred and became a new customer 1012 of the platform provider. In various embodiments, a share identifier 1016 may be used to identify the advertiser who referred other potential advertisers. For example, the share identifier may be a web link 1018 that when selected on the client sharing screen 1000, causes the sharing information and corresponding rewards to be recorded under the account of the advertiser performing self-registration. This way, the platform provider can identify, track, and reward the referring advertisers.

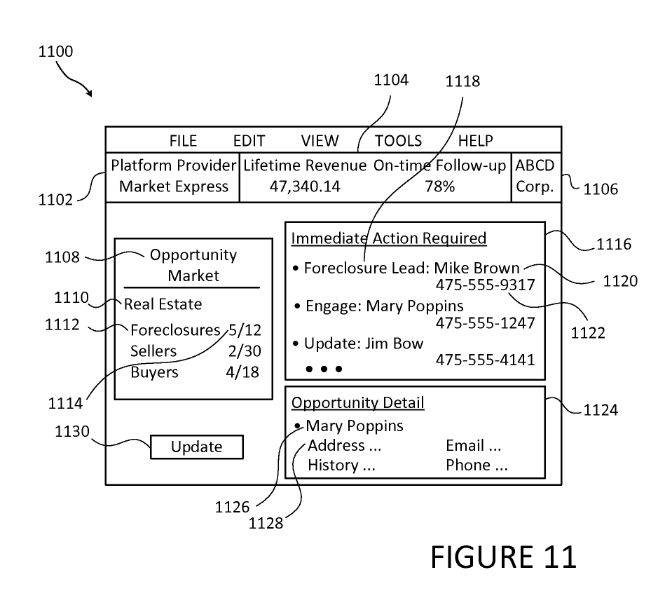

FIG. 11 shows an example computer user interface of the self-service marketplace platform of FIG. 4, configured to show a merchant's activity status and actions in the marketplace. In various embodiments, merchant dashboard screen 1100 including platform provider identification panel 1102, summary merchant or advertiser statistics panel 1104, merchant identification panel 1106, opportunity market panel 1108, market category identifier 1110, lead categories 1112, lead category activity data 1114, immediate actions panel 1116, lead product or category 1118 on which actions are to be taken, sales lead contact information such as name 1120 and phone number 1122, lead opportunity detail panel 1124 having contact information and other notes 1128 of a sales lead opportunity 1126, and an update button 1130.

In various embodiments, merchant dashboard screen 1100 provides general and specific information about the sales activities of the merchant/advertiser at glance, such that most sales related information with respect to the leads obtained from the lead marketplace may be quickly viewed. These information include statistics, activity summary, information about leads, and the like.

In various embodiments, summary merchant statistics panel includes various aggregate data about the advertiser's lead activities such as lifetime revenue obtained from the leads, percent on-time follow-up with obtained leads, and the like. In various embodiments, dashboard screen 1100 may be customized and/or configured to show various different statistics and other information based on user preferences. For example, the dashboard may provide a “Preferences” or “Options” menu or page that allows the customization of various information shown on the dashboard by the user. Such customizations may include statistics such as proportions of lead categories, revenues from each type of lead, annualized Return On Investment (ROI), and the like. Additionally, immediate actions panel 1116, opportunity marketplace panel 1108, and opportunity details panel 1124 may be configured to show different information based on user's options or preferences.

In various embodiments, immediate actions listed may be associated with alerts, reminders, and the like, to prompt the advertiser to take the actions in a timely manner. In some embodiments, the dashboard may include options for generating various types of reports for the advertiser including actions reports, statistics, revenues, ROI, staff performance, and the like.

In various embodiments, some of the actions are performed by the advertiser, while other actions may be automatically performed by the platform and/or the platform provider. For example, when a new lead opportunity is obtained, the first actions performed may be the automatic mailing of a postcard to the lead. Other actions may include a phone call, an email, a text message, or other communications to the lead; engagement with the lead in the sales process; asking for a sale from the lead; inviting the lead to an event such as a dinner or a free seminar; successfully closing the sale signified by a “Won” status; a “Status Update” or follow-up communication with the lead; and any other action that may assist the sales process.

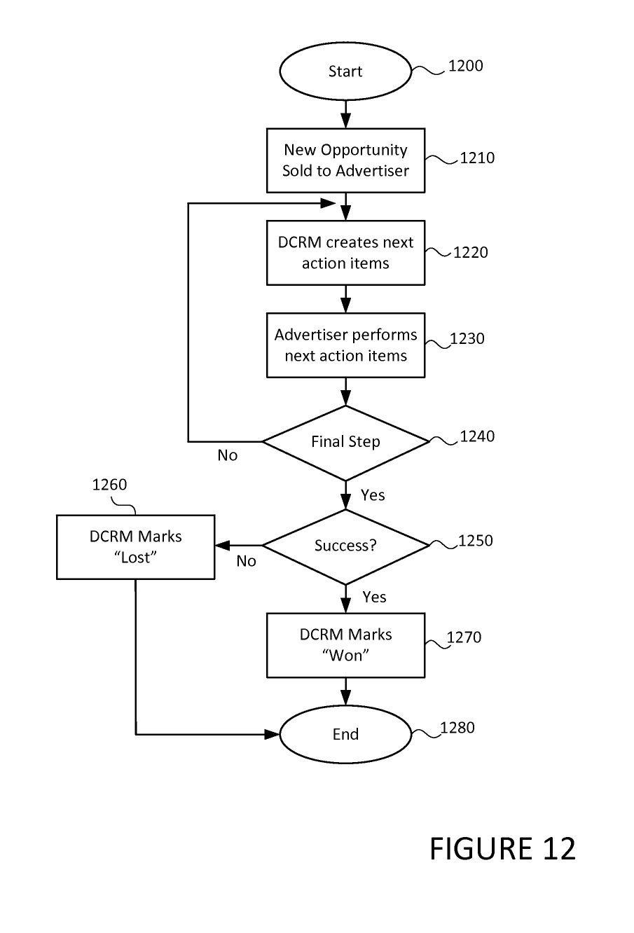

FIG. 12 shows an example flow diagram showing a process of taking actions on a lead opportunity obtained from the lead marketplace. In various embodiments, the actions processing starts at block 1200 and proceeds to block 1210 where a new opportunity in the form of a sales lead is purchased, given, or otherwise obtained by the advertiser. For example, the advertiser may have obtained the lead by purchasing it from the marketplace, or as incentive or reward. The process proceeds to block 1220.

At block 1220, in various embodiments, ACRM and/or DCRM creates next action items to be taken by the advertiser in regards to the lead opportunity. In some embodiments, the next action items are communicated to the advertiser via a communication channel such as email, text message, social network message, and the like. The action items may also be brought to the attention of the advertiser via the merchant dashboard, as described with respect to FIG. 11. In various embodiments, ACRM has the needed information for the advertiser, its preferences, constraints, requirements, special procedures, and the like and can formulate and schedule the action items to be consistent with the advertiser's operational requirements. In various embodiments, the actions may include a phone call, an email, a text message, or other communications to the lead; engagement with the lead in the sales process, such as understanding the lead's needs, requirements, constraints, financial qualifications, credit ratings, and the like; asking for a sale from the lead; inviting the lead to an event such as a dinner or a free seminar; successfully closing the sale signified by a “Won” status; a follow-up communication with the lead; and any other action that may help the advertiser achieve a “Won” status. The process proceeds to block 1230.

At block 1230, the advertiser performs the next action assigned by the ACRM in block 1220 and proceeds to decision block 1240.

At decision block 1240, it is determined whether the action performed in block 1220 is the final action. If so, the process moves to decision block 1250, otherwise it proceeds back to block 1220 for the next action.

At decision block 1250, it is ascertained whether the sale to the lead was successful. If so, the process moves to block 1270, otherwise it proceeds to block 1260.

At block 1260, DCRM or ACRM marks the lead as “lost” in its database, indicating failure in commercial sales to the lead, and proceeds to terminate at block 1280.

At block 1270, ACRM or DCRM marks the lead as “Won” in its database, indicating success in the commercial sales to the lead, and proceeds to terminate at block 1280.

According to action performance process 1200, all possible actions for sales to a lead opportunity are followed to conclusion to ensure no sales opportunity is missed due to oversight or lack of proper organization.

It will be understood that each step in the described processes above can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the disclosure.

Accordingly, combinations of steps of the described processes support combinations of means for performing the specified actions. It will also be understood that each step or combination of steps in the described processes can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A self-service system for creating a merchant computing platform, the system comprising:
a self-service computing platform module configured to allow creation of a customized computing platform and self-registration of a merchant thereon, wherein the customized computing platform is configured to allow the merchant to interact with an electronic sales marketplace; and
a Customer Relationship Management (CRM) module configured to allow management of interactions between the merchant and customers of the merchant.

2. The self-service system of claim 1, wherein the self-service computing platform module is provided by a platform provider.

3. The self-service system of claim 1, wherein the self-service computing platform is customized prior to the self-registration of the merchant.

4. The self-service system of claim 1, wherein the self-service computing platform is customized by a platform provider.

5. The self-service system of claim 1, wherein the self-service computing platform is web-based.

6. The self-service system of claim 1, wherein the self-registration includes a sequence of screens configured to collect information from the merchant.

7. The self-service system of claim 6, wherein the information collected from the merchant includes at least one of business category, merchant services, and merchant service area.

8. The self-service system of claim 6, wherein at least one screen in the sequence of screens includes offers to bid on sales leads.

9. A method of interacting with an electronic marketplace, the method comprising:
creating a self-service customized computing platform configured to allow interaction with an electronic marketplace;
self-registering by a merchant on the self-service customized computing platform; and
interacting with the electronic marketplace using the self-service customized computing platform.

10. The method of claim 9, further comprising using a Customer Relationship Management (CRM) module to manage interactions with customers of the merchant.

11. The method of claim 9, further comprising receiving sales leads as incentive to share information of other merchants using the self-service customized computing platform.

12. The method of claim 9, further comprising bidding for sales leads using the self-service customized computing platform.

13. The method of claim 9, further comprising a dynamic CRM (DCRM) module to update status of interactions with customers of the merchant.

14. The method of claim 9, further comprising a Advertiser CRM (ACRM) module to manage information about the merchant.

15. The method of claim 9, wherein the electronic marketplace is configured to buy and sell sales leads.

16. The method of claim 9, wherein the self-registering comprises providing information via a plurality of screens using the self-service customized computing platform.

17. A method of managing sales leads, the method comprising:
creating a self-service customized computing platform, by a merchant, configured to allow interaction with an electronic marketplace; and
managing interactions with customers of the merchant using a Customer Relationship Management (CRM) module.

18. The method of claim 17, wherein the self-service customized computing platform includes an merchant dashboard configured to display information about a status of the merchant's sales leads.

19. The method of claim 18, wherein a Dynamic CRM (DCRM) module is utilized to provide a list of actions, and updates to a status of the list of actions, on the merchant dashboard to be performed by the merchant in advancing the sales leads to successful sales.

20. The method of claim 19, wherein statistical data related to a performance of the merchant in managing the sales leads are displayed on the information dashboard.
